(19) United States
(12) Patent Application Publication
(10) Pub. No.: US 2012/0290338 A1
(43) Pub. Date: Nov. 15, 2012

(54) System and Method for Electronic Reservations, Booking, and Payments

(76) Inventor: Heath Joseph Gascoigne, London (GB)

(21) Appl. No.: 13/397,632

(22) Filed: Feb. 15, 2012

Related U.S. Application Data
(60) Provisional application No. 61/442,867, filed on Feb. 15, 2011.

(51) Int. Cl. G06Q 10/02; G06Q 30/02

(52) U.S. Cl. 705/5

(57) ABSTRACT

The present invention is a system and method for electronic reservations providing the ability to send and confirm bookings directly into a point of sale (POS) terminal. The POS can be either or both internal or external to the system. Additionally, Affiliate programs are included in the system. The system allows both advertising and booking managers to control the advertising and booking of time specific opportunities and services and the user to pay for the services provided by the system. The system also handles the distribution of payments and benefits to the Affiliates, Service Providers and Customers.

### CROSS REFERENCE TO RELATED APPLICATIONS

This application claims priority from U.S. Patent Application Ser. No. 61/442,867, entitled “System and Method for Electronic Reservations, Booking, and Payments”, filed on 15 Feb. 2011. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to reservations and booking methods. More specifically, the present invention relates to methods and electronic systems providing reservation, booking, and payments services.

### BACKGROUND OF THE INVENTION

Computer reservations systems, were originally designed in the mid-1960 to handle ticket transactions by airlines, and were later extended for the use of travel agents. Computer reservations systems that book and sell tickets for multiple airlines are known as global distribution systems. Airlines and other related industries have divested most of their direct holdings to dedicated global distribution systems companies, who make their systems accessible to consumers through Internet gateways. Modern global distribution systems typically allow users to book hotel rooms, make reservations at restaurants or entertainment venues, and reserve rental cars as well as purchase airline tickets.

The diversity and the specifics of the tourist products are limited by the utilities used to offer and conduct such transactions. Furthermore, small travel agencies and individual travel agents do not usually need the services provided by full scale booking systems in their entirety; they need functionality, which is tailored to solve the purpose-specific demand of their customers.

With the advent of modern travel technology and e-tourism having a convenient mechanism for order, discount and commission, it is therefore necessary to create a system and method for electronic reservations via a point of sale (POS) terminal in combination with access by both booking, advertising and payment managers.

### SUMMARY OF THE INVENTION

The present invention is a system and method for electronic reservations via a point of sale (POS) terminal. The POS terminal can be either or both internal or external to the system. Additionally, Affiliate programs are included in the system. The system allows the ability to send and confirm bookings directly into an existing (external) or internal POS terminal, as well are providing the ability for both booking, advertising and payment managers to control the booking of time specific opportunities and services; advertising and for the user to pay for the services provided by the system. The system also handles the distribution of payments and benefits to the Affiliates, Service Providers and Customers.

### BRIEF DESCRIPTION OF THE DRAWINGS

The accompanying drawings, which are incorporated herein form a part of the specification, illustrate the present invention and, together with the description, further serve to explain the principles of the invention and to enable a person skilled in the pertinent art to make and use the invention.

FIG. 1 is a flow chart illustrating booking via external POS system (EPOS);

FIG. 2 is a flow chart illustrating booking via a Booking manager (BA) (“App”) via a website with EPOS;

FIG. 3 is a flow chart illustrating booking via App on a social network website;

FIG. 4 is a flow chart illustrating booking via mobile App with EPOS;

FIG. 5 is a flow chart illustrating booking via a App on a third party website with EPOS;

FIG. 6 is a flow chart illustrating booking via a App on a directory website with EPOS;

FIG. 7 is a flow chart illustrating booking via an internal POS system (IPOS);

FIG. 8 is a flow chart illustrating the booking via an internal POS system with alternative systems such as those illustrated in FIGS. 3-6;

FIG. 9 is a flow chart illustrating booking via an IPOS with both EPOS and IPOS systems;

FIG. 10 is a flow chart illustrating booking via EPOS with both EPOS and IPOS systems;

FIG. 11 is a flow chart illustrating booking via a App on website with both EPOS and IPOS systems;

FIG. 12 is a flow chart illustrating booking via a mobile App with both EPOS and IPOS systems;

FIG. 13 is a flow chart illustrating booking via App on social network website with both EPOS and IPOS systems;

FIG. 14 is a flow chart illustrating booking via App on third party website with both EPOS and IPOS systems;

FIG. 15 is a flow chart illustrating booking via App on directory website with both EPOS and IPOS systems;

FIG. 16 is a flow chart illustrating booking with no POS system;

FIG. 17 is a flow chart illustrating the process of viewing availability with EPOS;

FIG. 18 is a flow chart illustrating the process of viewing availability with IPOS;

FIG. 19 is a flow chart illustrating the process of viewing availability with both EPOS and IPOS systems;

FIG. 20 is a flow chart illustrating the process of viewing availability with no POS systems; and

FIG. 21 is a system context diagram.

### DEFINITIONS

“App” is defined as an application, typically a small, specialized program downloaded onto mobile devices.

“POS” is defined as point of sale.

“ePOS” is defined as an external point of sale.

“iPOS” is defined as an internal point of sale.

“social networking website” is defined as the phrase used to describe any website that enables users to create public profiles within that website and form relationships with other users of the same website who access their profile. Social networking sites can be used to describe community-based website, online discussions forums, chatrooms and other social spaces online.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Now referring to the Figures, the embodiment of the present invention is a system and method for electronic reservations involving a point of sale (POS) terminal. The POS can be either or both internal or external to the system. Additionally, Affiliate programs are included in the system.

The system allows the ability to send and confirm bookings directly into an existing (external) or internal POS terminal, as well are providing the ability for both booking, advertising and payment managers to control the booking of time specific opportunities and services; advertising and for the user to pay for the services provided by the system. The system also handles the distribution of payments and benefits to the Affiliates, Service Providers and Customers.

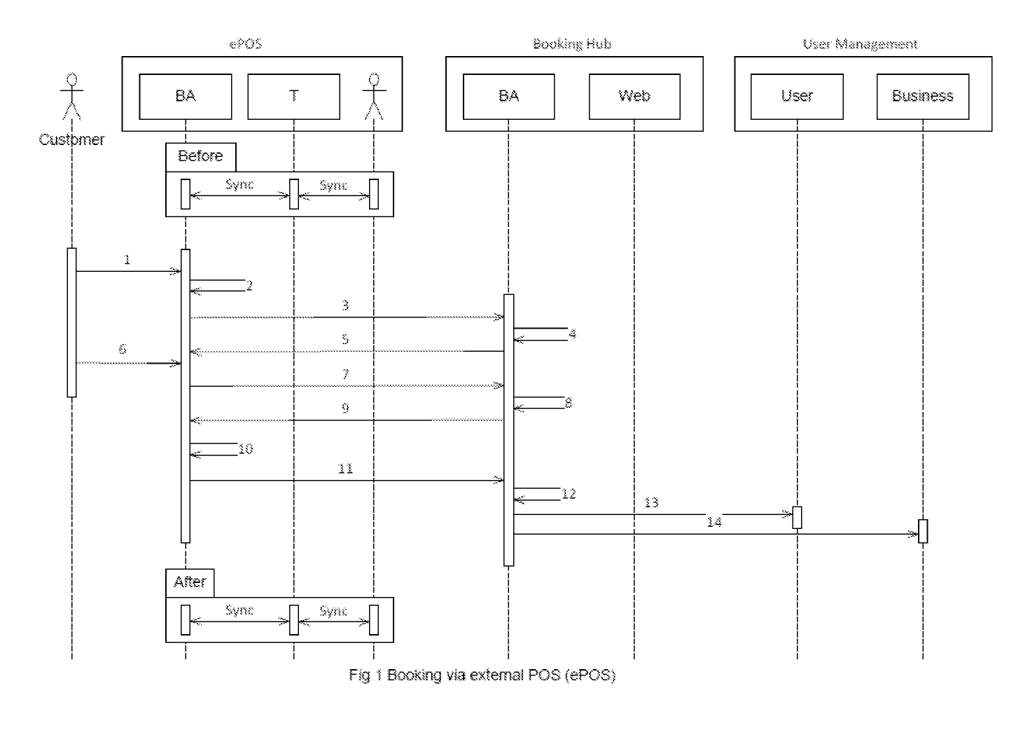

FIG. 1 is a flow chart illustrating booking via external POS system (EPOS). The EPOS sends and receives information to and from a user and can check availability of an event and confirm availability to a user by access to a booking hub. The booking hub consists of a system website and booking manager, application (App), advertising manager, and payment manager. The booking manager receives the availability inquiry and provides confirmation and reservation actions as well as updating and tracking availability by allocating and blocking openings for the business. The user management module provides both user and business account information and tracking. When a reservation is made in the system, both the user and business accounts are updated and credited appropriately.

The booking hub may also update the user account, assign booking to the user account, and assign reward points to the user account. Points are accumulated by users and may be later redeemed for services for free or offered at a discount in exchange for the redemption of points.

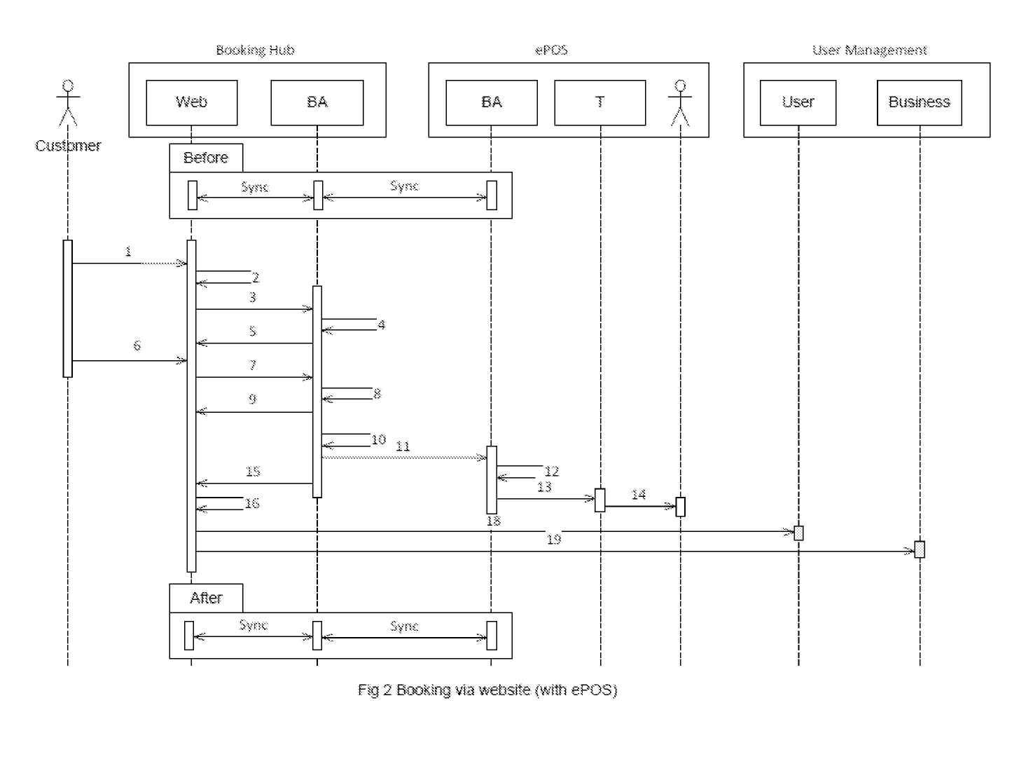

FIG. 2 is a flow chart illustrating booking via App on website with EPOS. In this embodiment, the system website and booking manager comprise the booking hub. The booking manager sends and receives information to and from a user and can check availability of an event and confirm availability to a user by access to a booking manager. The booking hub consists of a system website and server and booking manager. The booking manager receives the availability inquiry and provides confirmation and reservation actions as well as updating and tracking availability by allocating and blocking openings for the business and communicates with the EPOS. The user management module provides both user and business account information and tracking. When a reservation is made in the system, both the user and business accounts are updated and credited appropriately. In this embodiment it is assumed that the booking manager has availability from the EPOS and the website does not need to confirm availability, via the booking manager, with the EPOS. The EPOS can either always make booking available to the booking manager or it can be called upon as necessary by the booking manager to provide or confirm availability.

The booking hub may also update the user account, assign booking to the user account, and assign reward points to the user account. Points are accumulated by users and may be later redeemed for services for free or offered at a discount in exchange for the redemption of points.

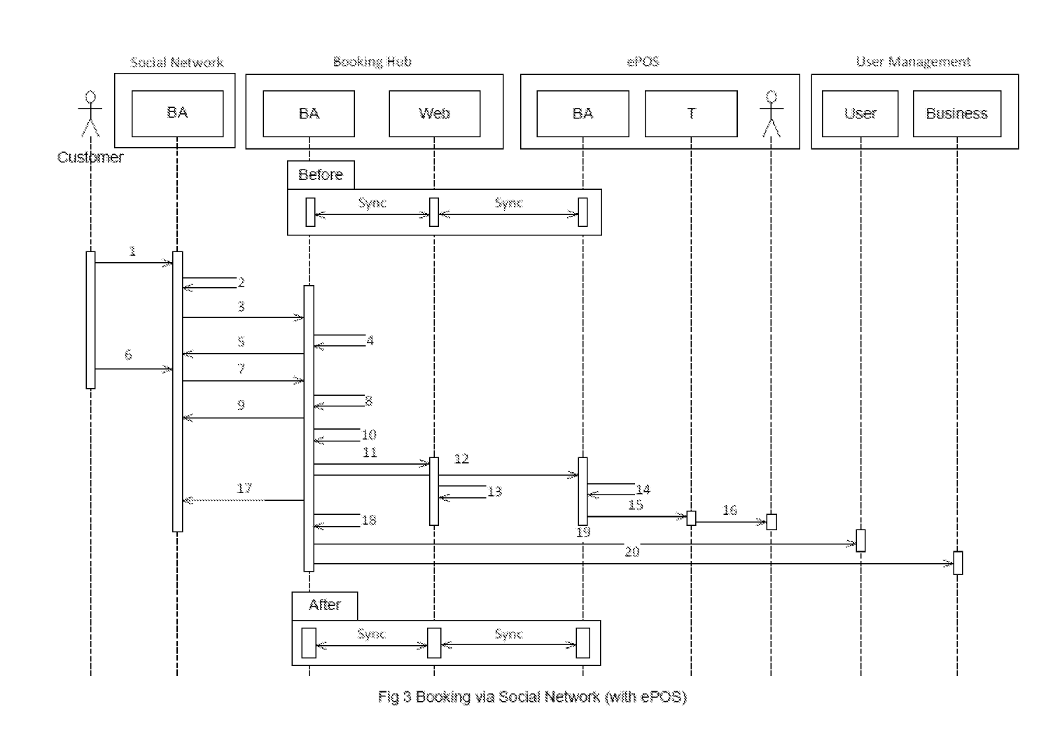

FIG. 3 is a flow chart illustrating booking via App on a social network website such as FACEBOOK. Implementation of the invention in a social network website or application such as FACEBOOK, the App on the social network website sends and receives information to and from a user and can check availability of an event and confirm availability to a user by access to a booking hub. The booking hub consists of a system website and server and booking manager. The booking manager receives the availability inquiry and provides confirmation and reservation actions as well as updating and tracking availability by allocating and blocking openings for the business and communicates with the EPOS. The user management module provides both user and business account information and tracking. When a reservation is made in the system, both the user and business accounts are updated and credited appropriately.

The booking hub may also update the user account, assign booking to the user account, and assign reward points to the user account. Points are accumulated by users and may be later redeemed for services for free or offered at a discount in exchange for the redemption of points.

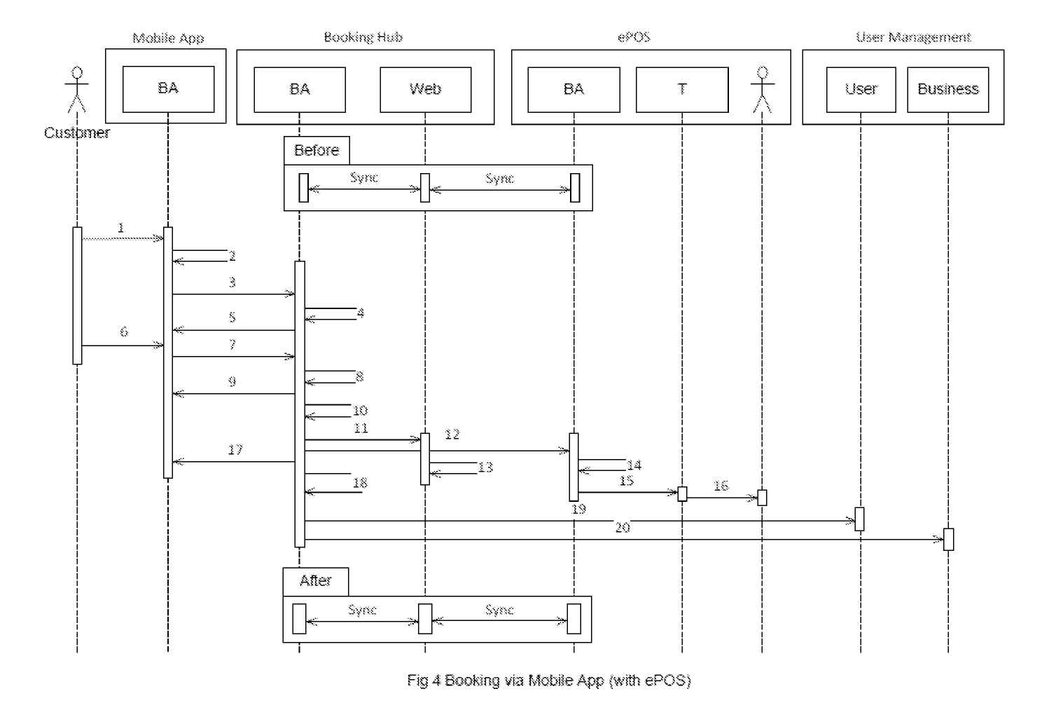

FIG. 4 is a flow chart illustrating booking via mobile App, including mobile devices, tablet/IPAD and Phone/Smartphone applications with EPOS. Implementation of the invention in a mobile App, the mobile App sends and receives information to and from a user and can check availability of an event and confirm availability to a user by access to a booking hub. The booking hub consists of a system website and server and booking manager. The booking manager receives the availability inquiry and provides confirmation and reservation actions as well as updating and tracking availability by allocating and blocking openings for the business and communicates with the EPOS. The user management module provides both user and business account information and tracking. When a reservation is made in the system, both the user and business accounts are updated and credited appropriately.

The booking hub may also update the user account, assign booking to the user account, and assign reward points to the user account. Points are accumulated by users and may be later redeemed for services for free or offered at a discount in exchange for the redemption of points.

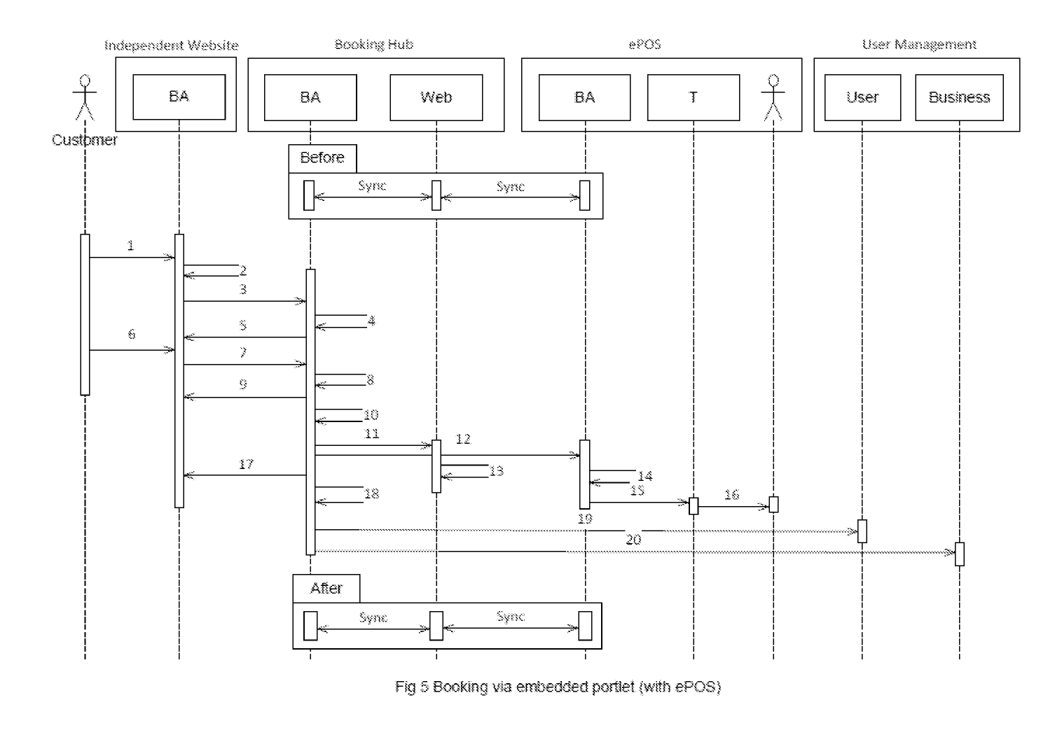

FIG. 5 is a flow chart illustrating booking via a App embedded in an third party website with EPOS. Implementation of the invention in an third party website, the App sends and receives information to and from a user and can check availability of an event and confirm availability to a user by access to a booking hub. The booking hub consists of a system website and server and booking manager. The booking manager receives the availability inquiry and provides confirmation and reservation actions as well as updating and tracking availability by allocating and blocking openings for the business and communicates with the EPOS. The user management module provides both user and business account information and tracking. When a reservation is made in the system, both the user and business accounts are updated and credited appropriately.

In this embodiment, the website with EPOS may be any third party website or it may be the website owned and/or operated by a specific business that incorporates the App into their own website rather than that operated or owned by a third party.

The booking hub may also update the user account, assign booking to the user account, and assign reward points to the user account. Points are accumulated by users and may be later redeemed for services for free or offered at a discount in exchange for the redemption of points.

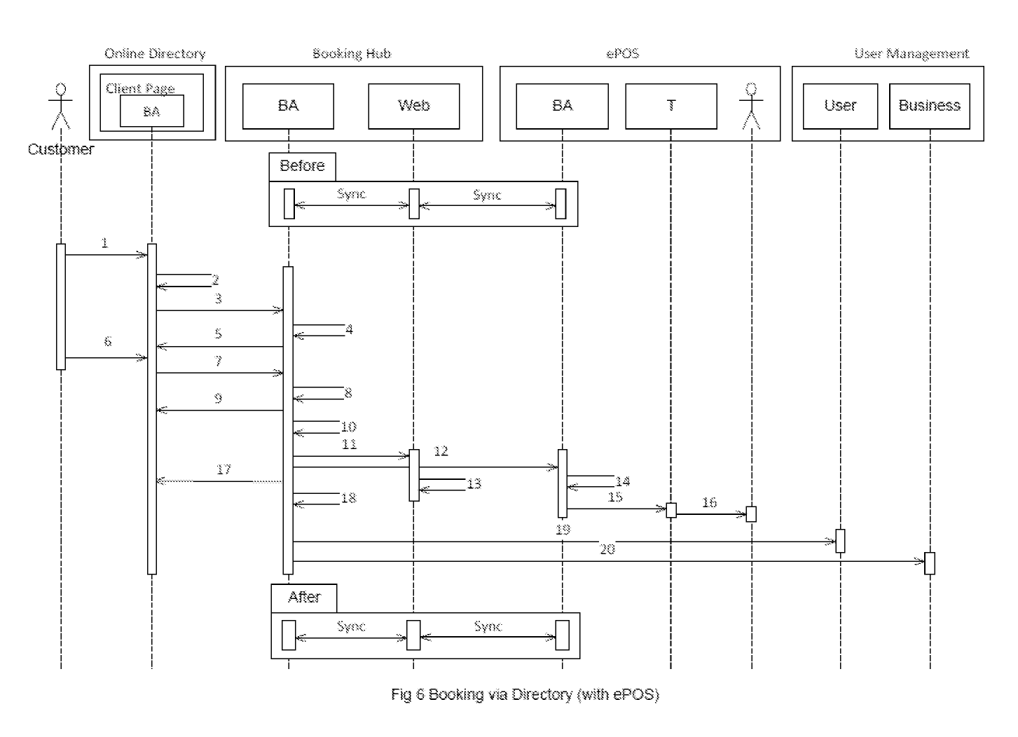

FIG. 6 is a flow chart illustrating booking via a App on a directory website with EPOS. Implementation of the invention in a directory website, the App sends and receives information to and from a user and can check availability of an event and confirm availability to a user by access to a booking hub. The booking hub consists of a system website and server and booking manager. The booking manager receives the availability inquiry and provides confirmation and reservation actions as well as updating and tracking availability by allocating and blocking openings for the business and communicates with the EPOS. The user management module provides both user and business account information and tracking. When a reservation is made in the system, both the user and business accounts are updated and credited appropriately.

The booking hub may also update the user account, assign booking to the user account, and assign reward points to the user account. Points are accumulated by users and may be later redeemed for services for free or offered at a discount in exchange for the redemption of points.

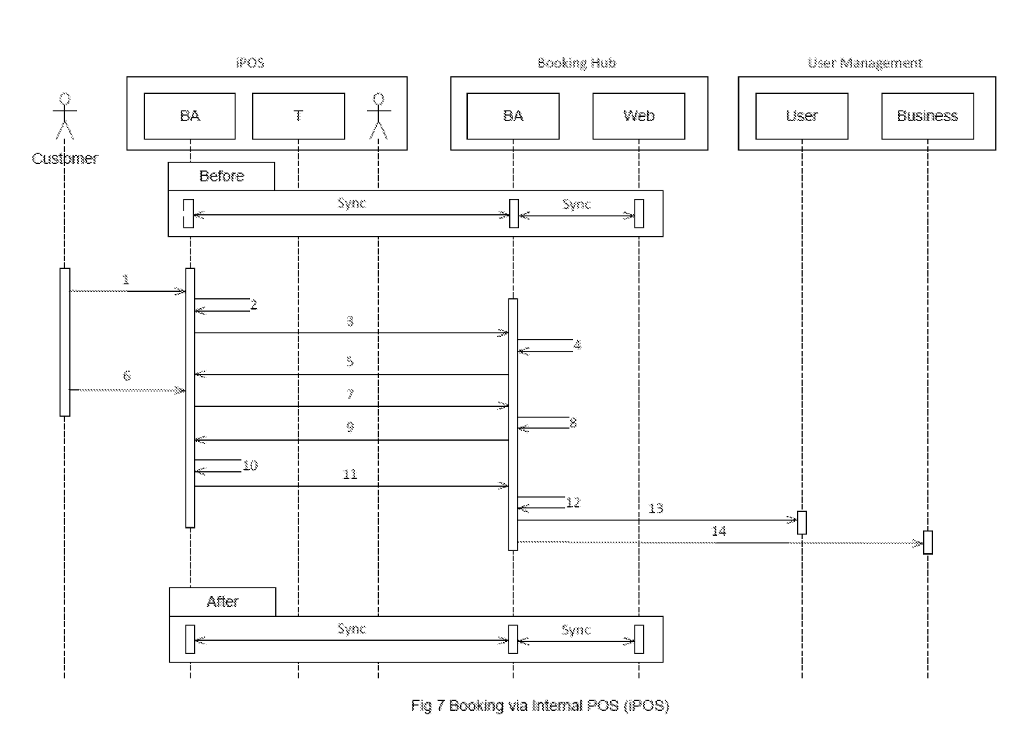

FIG. 7 is a flow chart illustrating booking via an internal POS system (IPOS). Implementation of the invention in an IPOS, the IPOS sends and receives information to and from a user and can check availability of an event and confirm availability to a user by access to a booking hub. The booking hub consists of a system website and server and booking manager. The booking manager receives the availability inquiry and provides confirmation and reservation actions as well as updating and tracking availability by allocating and blocking openings for the business and communicates with the booking hub. The user management module provides both user and business account information and tracking. When a reservation is made in the system, both the user and business accounts are updated and credited appropriately.

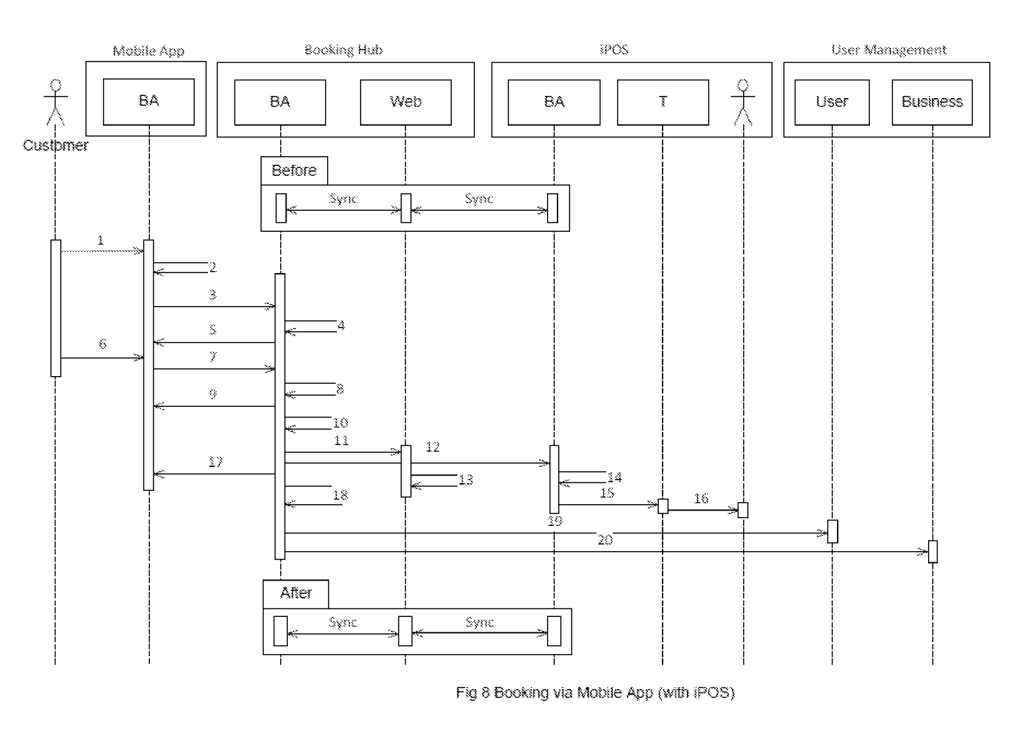

IPOS may replace the EPOS in the embodiment of FIG. 3, FIG. 4 for the social network embodiment by again replacing the EPOS with IPOS. In FIG. 5, IPOS can replace EPOS in the portal embodiment of the invention as well as in the directory embodiment of FIG. 6. By merely replacing IPOS for EPOS, the invention can be practiced with an internal or external POS communicating with the front end and/or booking hub. Applicant has not repeated FIGS. 3-6 as it would be obvious to replace the EPOS in those figures with an IPOS box for illustration purposes. FIG. 8 is a flow chart illustrating the booking via an internal POS system with alternative systems such as those illustrated in FIGS. 3-6. In FIG. 8, the reference to “2.3” is to FIG. 3, the reference to “2.4” is to FIG. 4, the reference to “2.5” is to FIG. 5, and the reference to “2.6” is to FIG. 6.

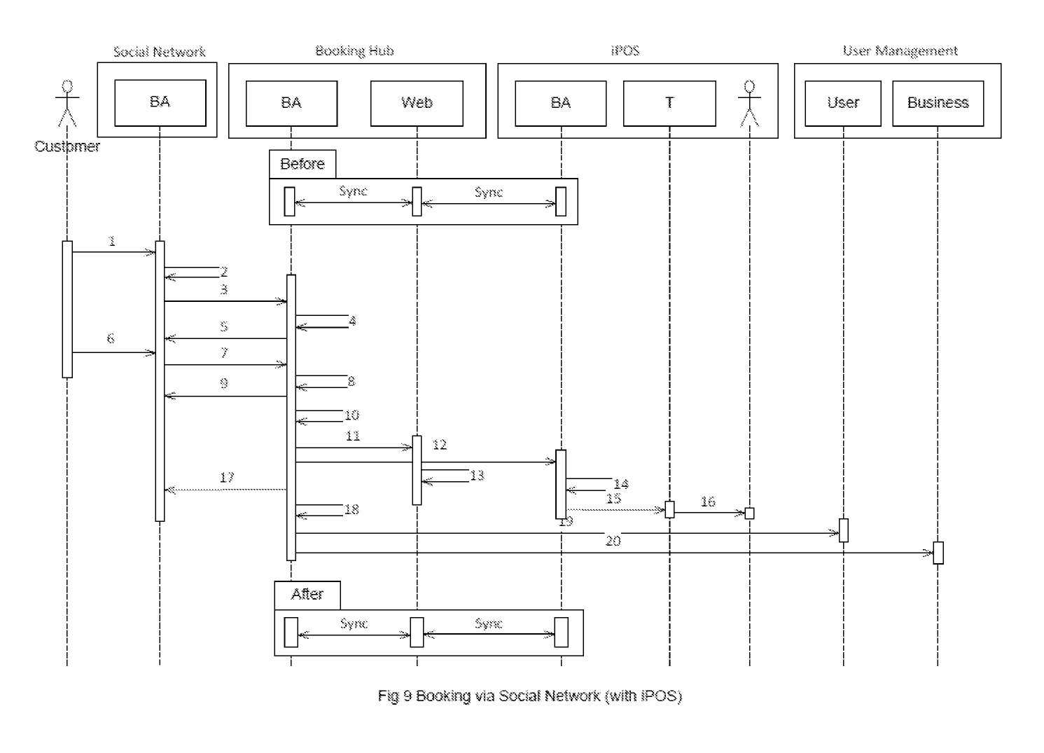

FIG. 9 is a flow chart illustrating booking via an IPOS with both EPOS and IPOS systems. Implementation of the invention with both EPOS and IPOS, the IPOS sends and receives information to and from a user and can check availability of an event and confirm availability to a user by access to a booking hub. The booking hub consists of a system website and server and booking manager. The booking manager receives the availability inquiry and provides confirmation and reservation actions as well as updating and tracking availability by allocating and blocking openings for the business and communicates with the EPOS. The user management module provides both user and business account information and tracking. When a reservation is made in the system, both the user and business accounts are updated and credited appropriately.

The booking hub may also update the user account, assign booking to the user account, and assign reward points to the user account. Points are accumulated by users and may be later redeemed for services for free or offered at a discount in exchange for the redemption of points.

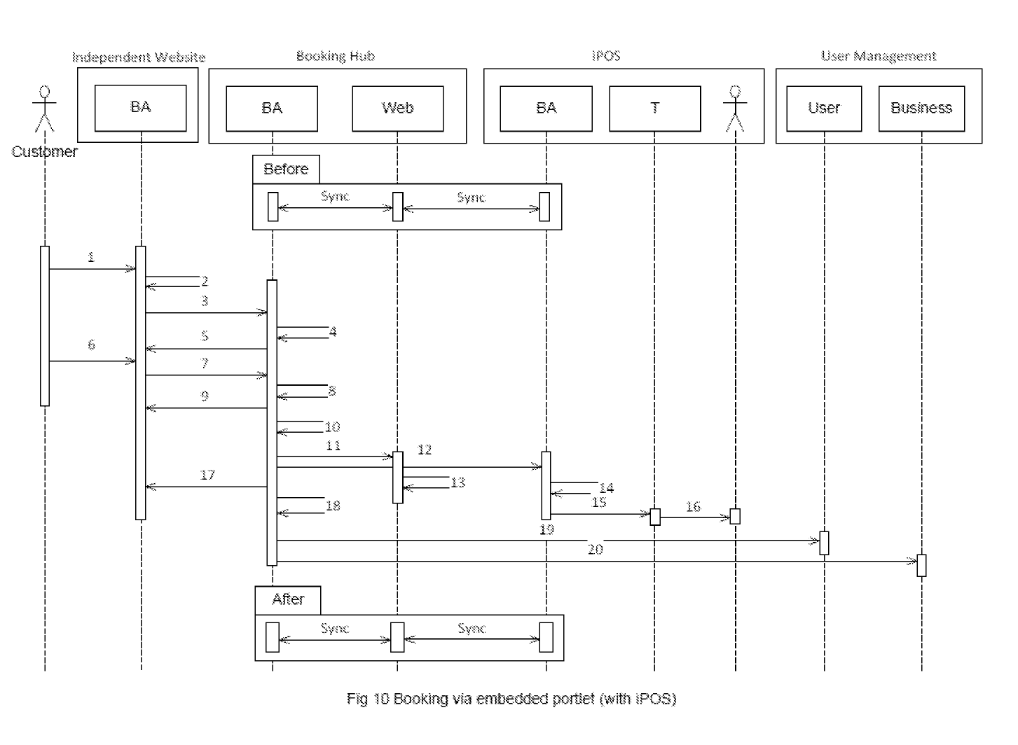

FIG. 10 is a flow chart illustrating booking via EPOS with both EPOS and IPOS systems. Compared to FIG. 9, the EPOS and IPOS labels are merely switched to illustrate the new location of each module. Implementation of the invention with both EPOS and IPOS, the EPOS sends and receives information to and from a user and can check availability of an event and confirm availability to a user by access to a booking hub. The booking hub consists of a system website and server and booking manager. The booking manager receives the availability inquiry and provides confirmation and reservation actions as well as updating and tracking availability by allocating and blocking openings for the business and communicates with the IPOS. The user management module provides both user and business account information and tracking. When a reservation is made in the system, both the user and business accounts are updated and credited appropriately.

The booking hub may also update the user account, assign booking to the user account, and assign reward points to the user account. Points are accumulated by users and may be later redeemed for services for free or offered at a discount in exchange for the redemption of points.

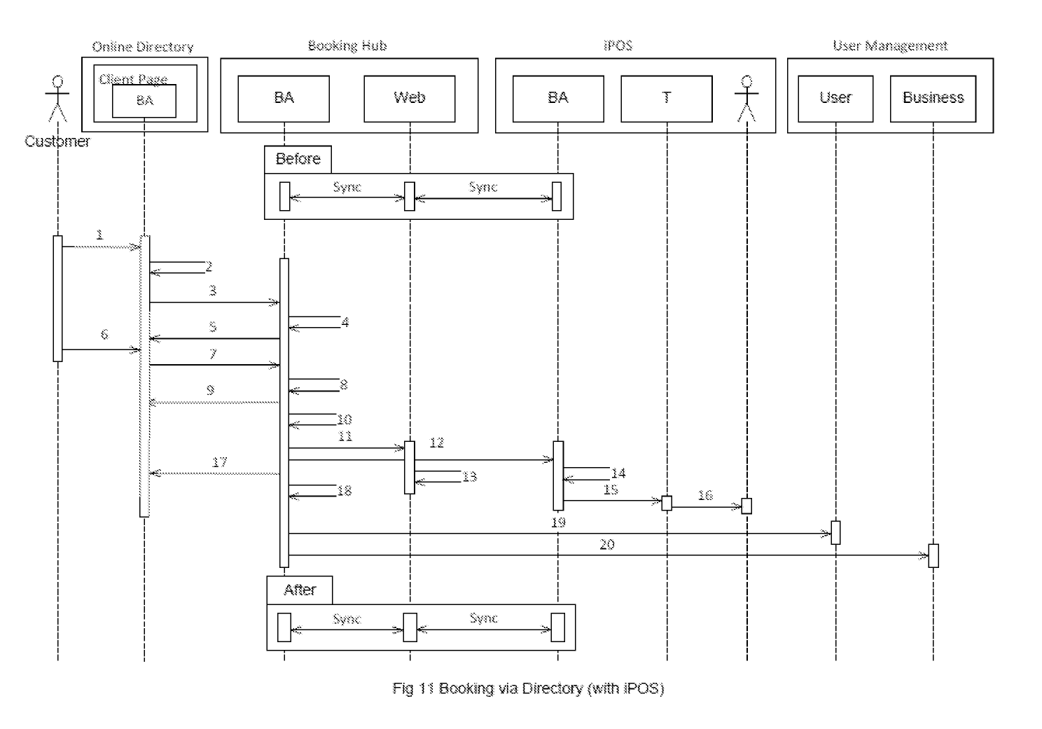

FIG. 11 is a flow chart illustrating booking via a App on website with both EPOS and IPOS systems. Implementation of the invention in a website with both EPOS and IPOS, the App sends and receives information to and from a user and can check availability of an event and confirm availability to a user by access to a booking hub. The booking hub consists of a system website and server and booking manager. The booking manager receives the availability inquiry and provides confirmation and reservation actions as well as updating and tracking availability by allocating and blocking openings for the business and communicates with the EPOS and IPOS. The user management module provides both user and business account information and tracking. When a reservation is made in the system, both the user and business accounts are updated and credited appropriately.

The booking hub may also update the user account, assign booking to the user account, and assign reward points to the user account. Points are accumulated by users and may be later redeemed for services for free or offered at a discount in exchange for the redemption of points.

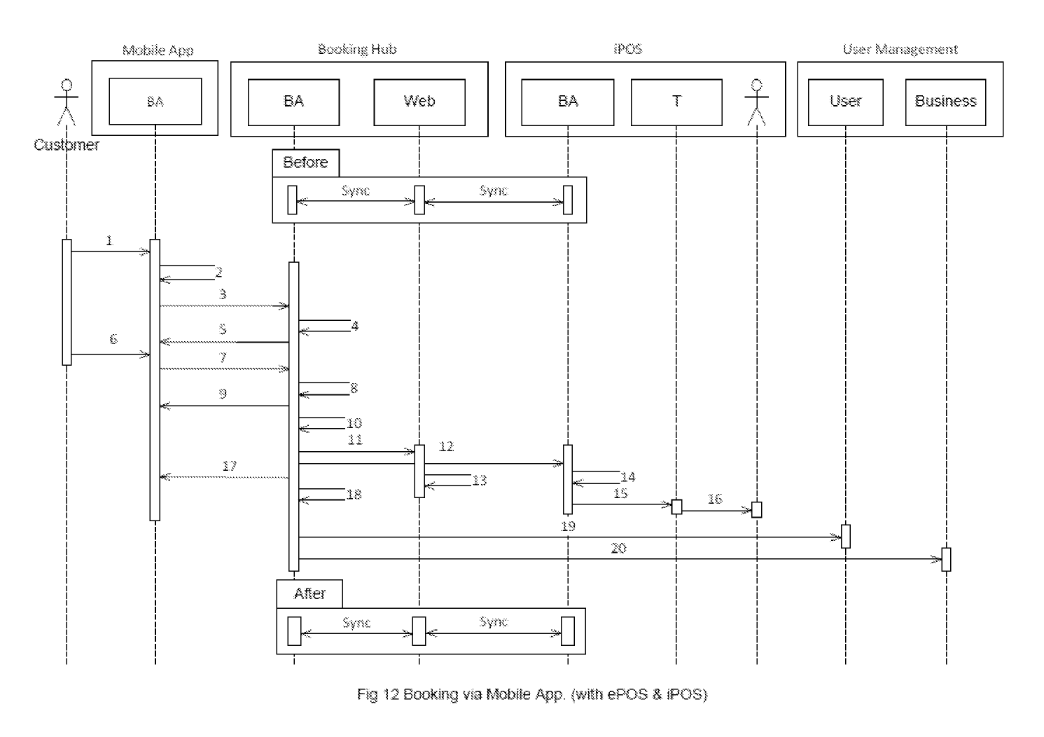

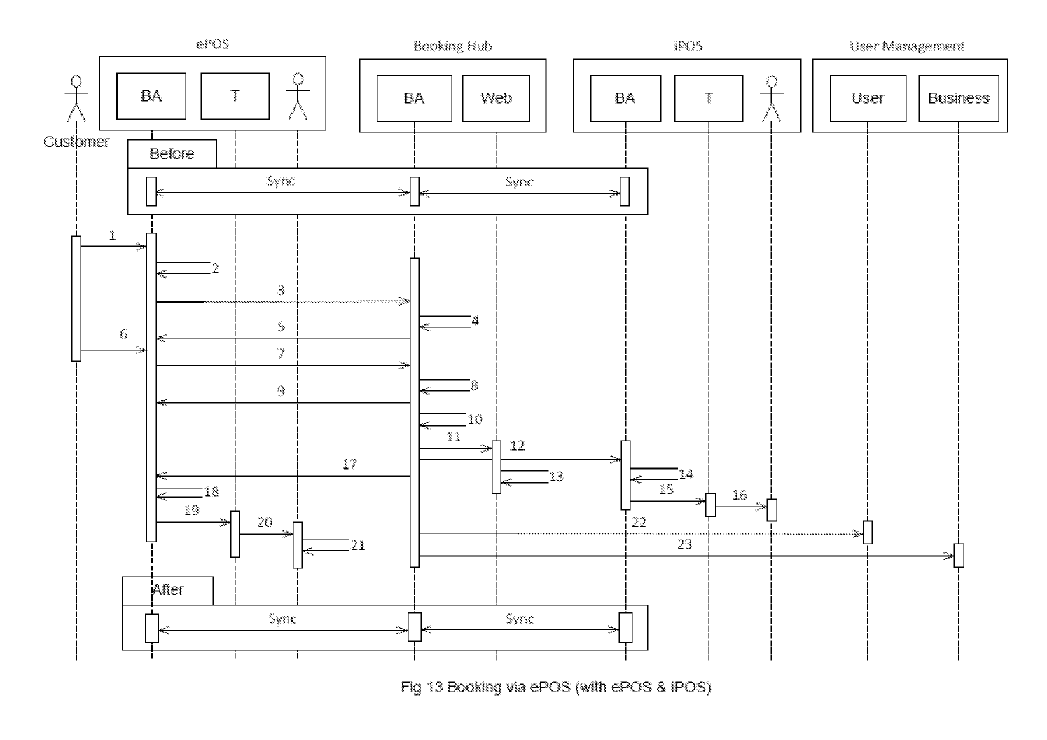

FIG. 12 is a flow chart illustrating booking via a mobile App including mobile devices, tablet/IPAD and Phone/Smartphone applications with both EPOS and IPOS systems. Implementation of the invention in a mobile App, the mobile App sends and receives information to and from a user and can check availability of an event and confirm availability to a user by access to a booking hub. The booking hub consists of a system website and server and booking manager. The booking manager receives the availability inquiry and provides confirmation and reservation actions as well as updating and tracking availability by allocating and blocking openings for the business and communicates with the EPOS and IPOS. The user management module provides both user and business account information and tracking. When a reservation is made in the system, both the user and business accounts are updated and credited appropriately.

The booking hub may also update the user account, assign booking to the user account, and assign reward points to the user account. Points are accumulated by users and may be later redeemed for services for free or offered at a discount in exchange for the redemption of points.

FIG. 13 is a flow chart illustrating booking via a App on social network website with both EPOS and IPOS systems. Implementation of the invention on a social network website with both EPOS and IPOS, the App on the social network booking website sends and receives information to and from a user and can check availability of an event and confirm availability to a user by access to a booking hub. The booking hub consists of a system website and server and booking manager. The booking manager receives the availability inquiry and provides confirmation and reservation actions as well as updating and tracking availability by allocating and blocking openings for the business and communicates with the EPOS and IPOS. The user management module provides both user and business account information and tracking. When a reservation is made in the system, both the user and business accounts are updated and credited appropriately.

The booking hub may also update the user account, assign booking to the user account, and assign reward points to the user account. Points are accumulated by users and may be later redeemed for services for free or offered at a discount in exchange for the redemption of points.

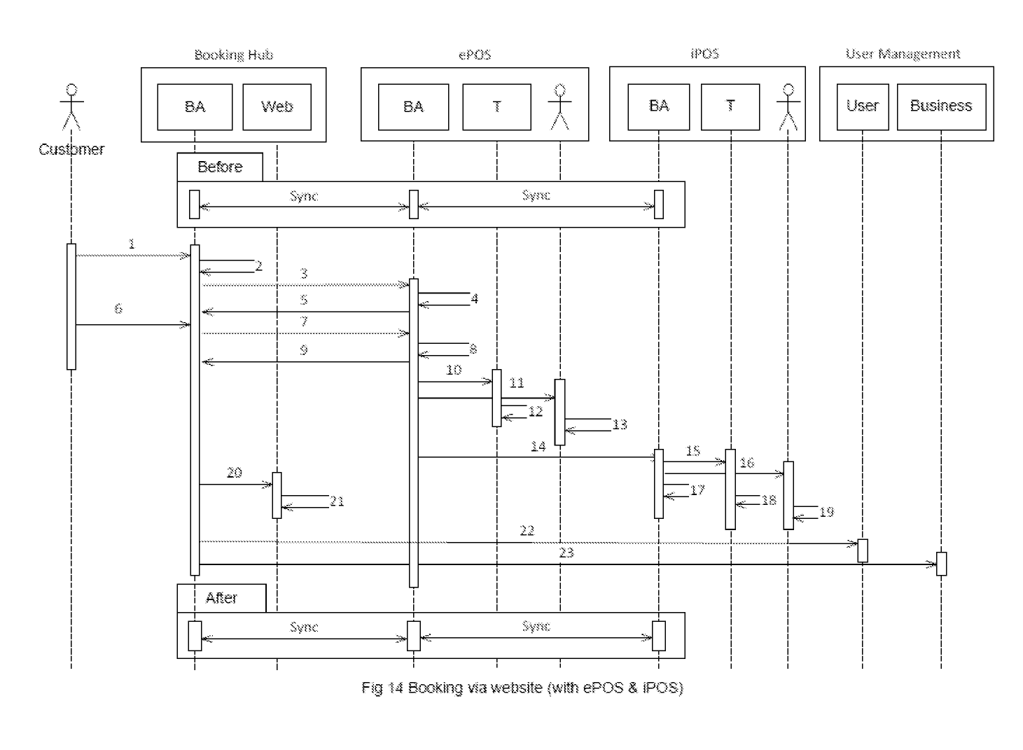

FIG. 14 is a flow chart illustrating booking via a App on the website with both EPOS and IPOS systems. Implementation of the invention in a website with both EPOS and IPOS, the App sends and receives information to and from a user and can check availability of an event and confirm availability to a user by access to a booking hub. The booking hub consists of a system website and server and booking manager. The booking manager receives the availability inquiry and provides confirmation and reservation actions as well as updating and tracking availability by allocating and blocking openings for the business and communicates with the EPOS and IPOS. The user management module provides both user and business account information and tracking. When a reservation is made in the system, both the user and business accounts are updated and credited appropriately.

The booking hub may also update the user account, assign booking to the user account, and assign reward points to the user account. Points are accumulated by users and may be later redeemed for services for free or offered at a discount in exchange for the redemption of points.

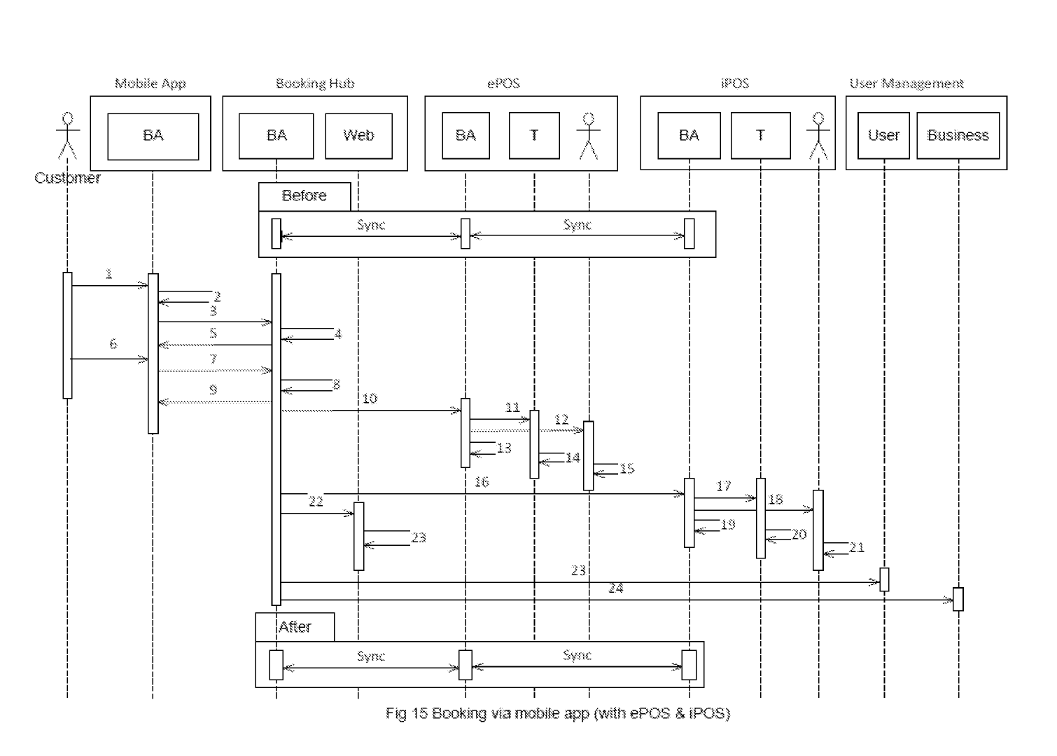

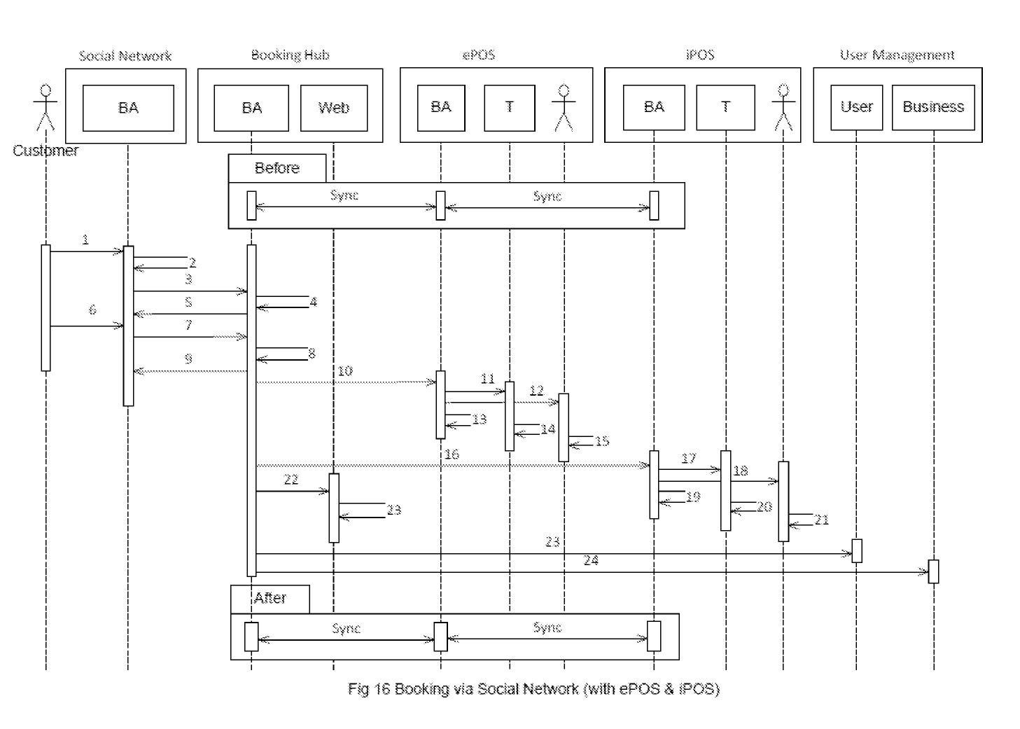

FIG. 15 is a flow chart illustrating booking via a App on a directory website with both EPOS and IPOS systems. Implementation of the invention in a directory website, the App sends and receives information to and from a user and can check availability of an event and confirm availability to a user by access to a booking hub. The booking hub consists of a system website and server and booking manager. The booking manager receives the availability inquiry and provides confirmation and reservation actions as well as updating and tracking availability by allocating and blocking openings for the business and communicates with the EPOS and IPOS. The user management module provides both user and business account information and tracking When a reservation is made in the system, both the user and business accounts are updated and credited appropriately.

The booking hub may also update the user account, assign booking to the user account, and assign reward points to the user account. Points are accumulated by users and may be later redeemed for services for free or offered at a discount in exchange for the redemption of points.

FIG. 16 is a flow chart illustrating booking via a website with no POS system. Implementation of the invention with no POS systems, the user directly accesses the booking hub by the system website and server and the system sends and receives information to and from a user via the booking hub and can check availability of an event and confirm availability to a user by access the booking manager in the booking hub. The booking hub consists of a system website and server and booking manager. The booking manager receives the availability inquiry and provides confirmation and reservation actions as well as updating and tracking availability by allocating and blocking openings for the business from the booking manager and communicates booking information to booking managers located on social websites and/or mobile applications. The user management module provides both user and business account information and tracking. When a reservation is made in the system, both the user and business accounts are updated and credited appropriately.

The booking hub may also update the user account, assign booking to the user account, and assign reward points to the user account. Points are accumulated by users and may be later redeemed for services for free or offered at a discount in exchange for the redemption of points.

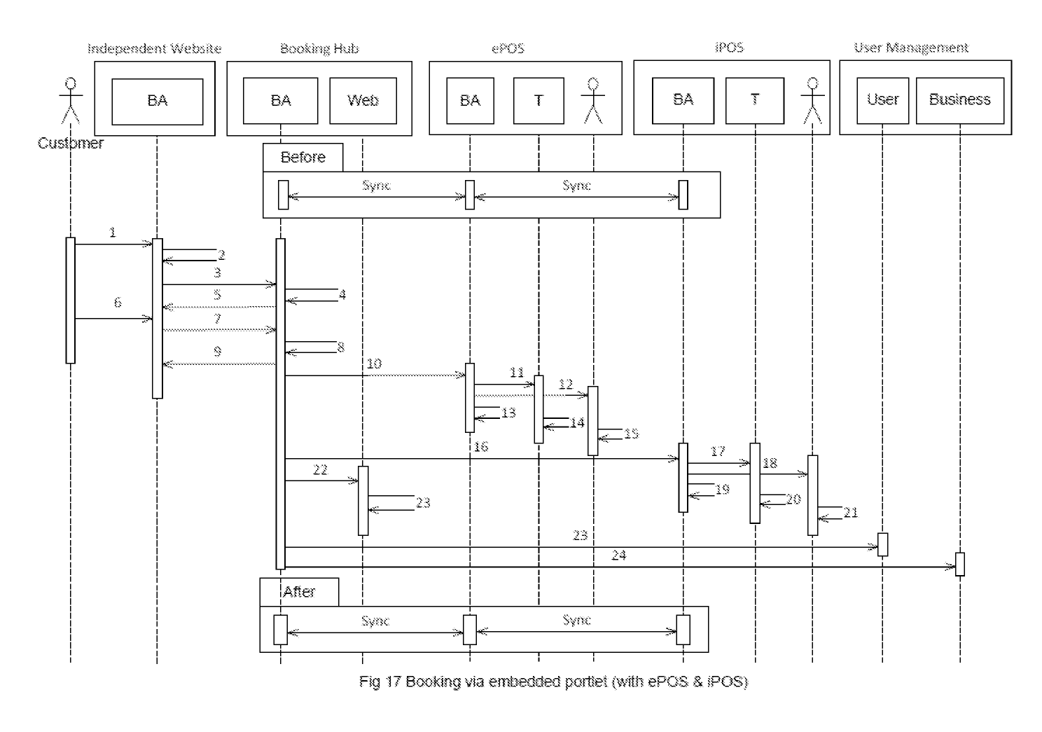

FIG. 17 is a flow chart illustrating the process of viewing availability with EPOS. A user accesses the booking hub to view the availability of services. The booking hub consists of a system website and server and booking manager. The booking hub validates, checks with the EPOS, and returns the EPOS results as a display to the system website for the user to view.

The booking hub may also update the user account, assign booking to the user account, and assign reward points to the user account. Points are accumulated by users and may be later redeemed for services for free or offered at a discount in exchange for the redemption of points.

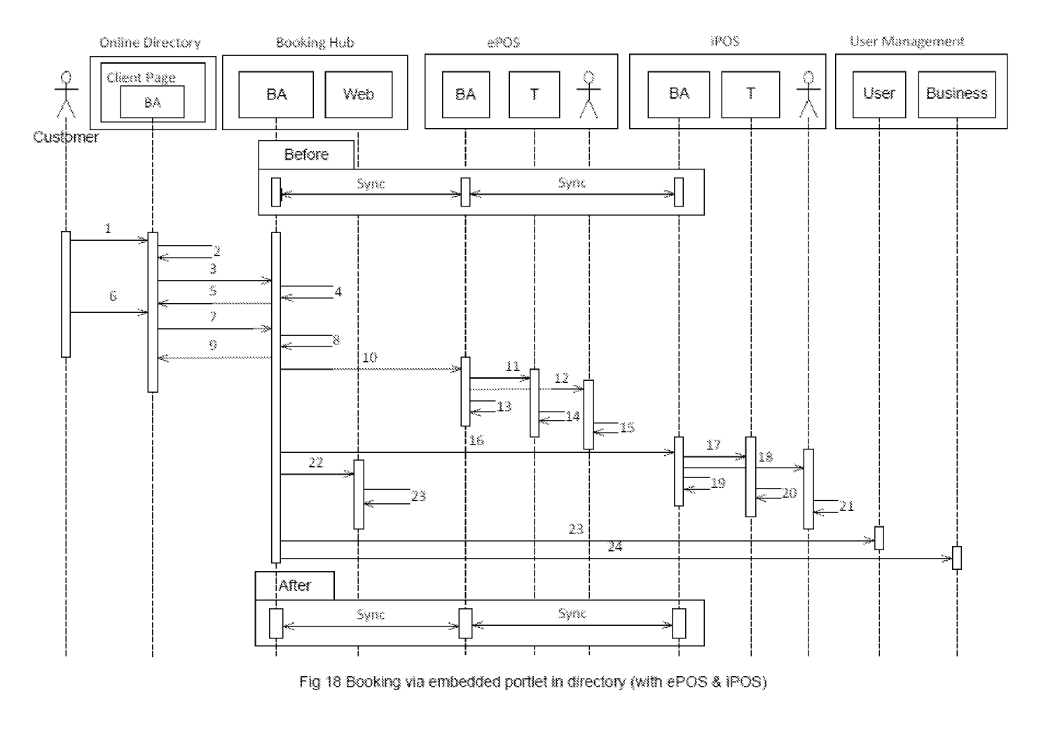

FIG. 18 is a flow chart illustrating the process of viewing availability with IPOS. A user accesses the booking hub to view the availability of services. The booking hub consists of a system website and server and booking manager. The booking hub validates, checks with the EPOS, and returns the EPOS results as a display to the system website for the user to view.

The booking hub may also update the user account, assign booking to the user account, and assign reward points to the user account. Points are accumulated by users and may be later redeemed for services for free or offered at a discount in exchange for the redemption of points.

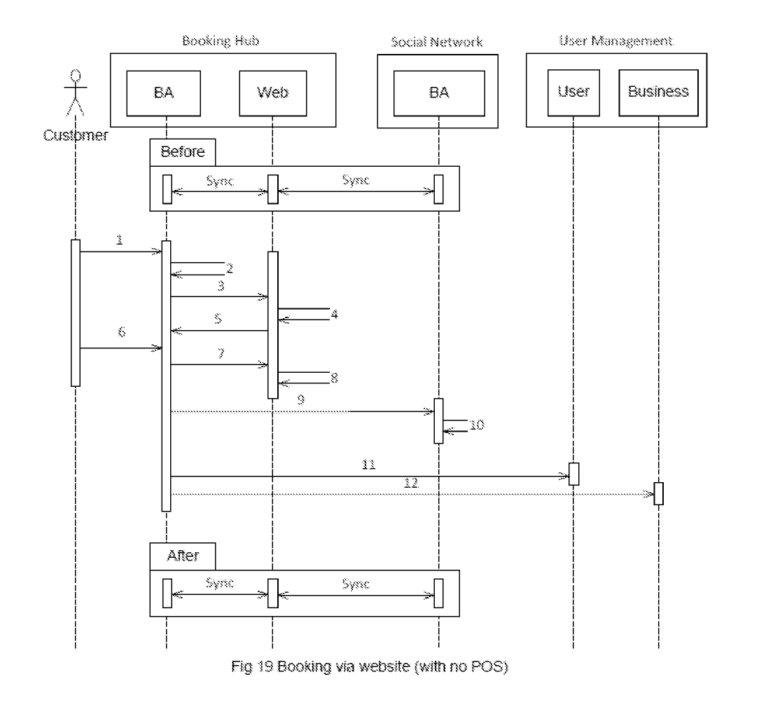

FIG. 19 is a flow chart illustrating the process of viewing availability with both EPOS and IPOS systems. A user accesses the booking hub to view the availability of services. The booking hub consists of a system website and server and booking manager. The booking hub validates, checks with the EPOS, and IPOS and returns the EPOS and IPOS results as a display to the system website for the user to view.

The booking hub may also update the user account, assign booking to the user account, and assign reward points to the user account. Points are accumulated by users and may be later redeemed for services for free or offered at a discount in exchange for the redemption of points.

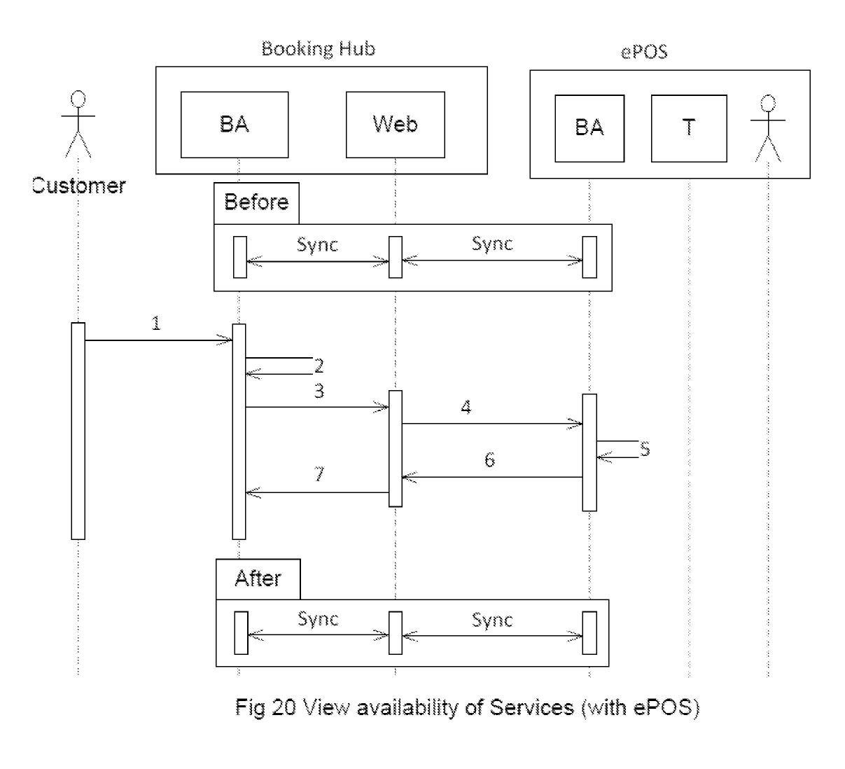

FIG. 20 is a flow chart illustrating the process of viewing availability with no POS systems. A user accesses the booking hub to view the availability of services. The booking hub consists of a system website and server and booking manager. The booking hub validates and checks availability via the booking manager and returns the results as a display to the system website for the user to view.

The booking hub may also update the user account, assign booking to the user account, and assign reward points to the user account. Points are accumulated by users and may be later redeemed for services for free or offered at a discount in exchange for the redemption of points.

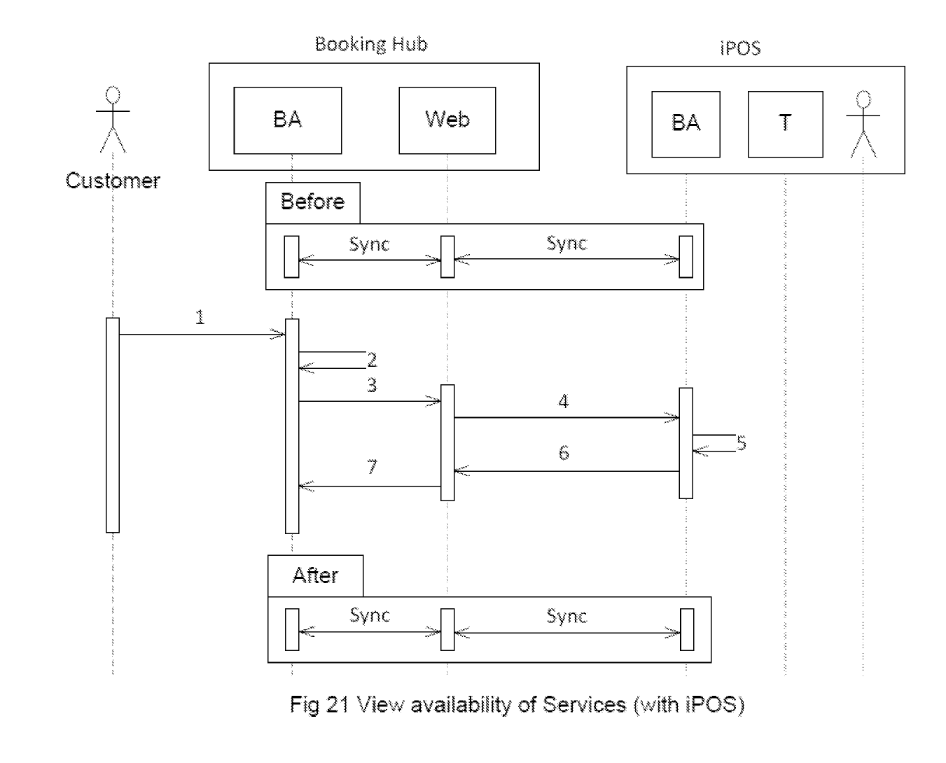

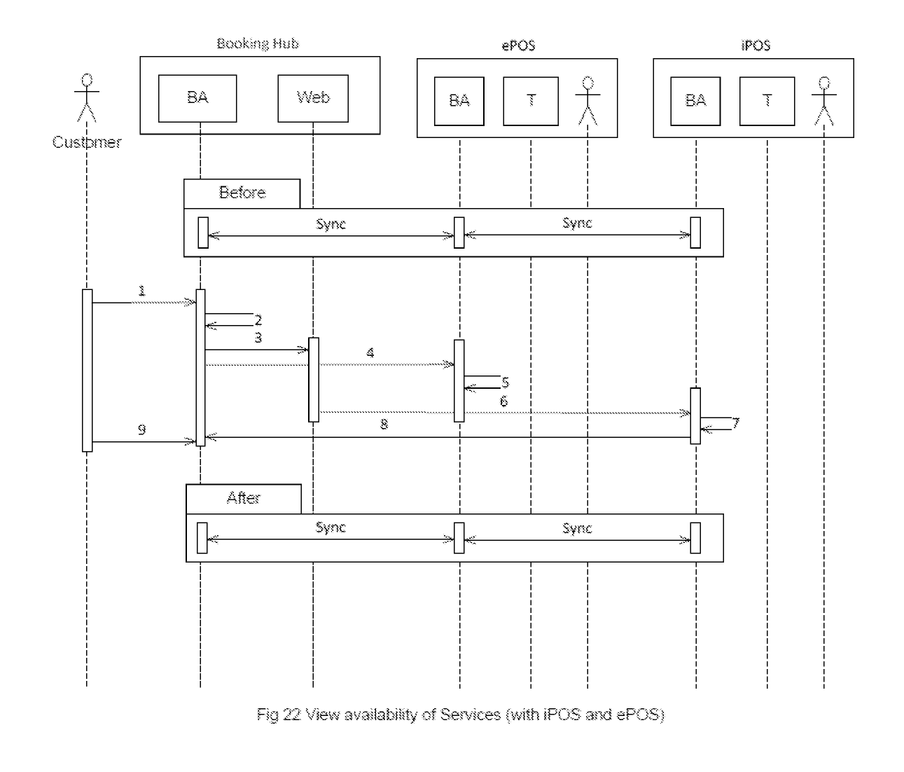

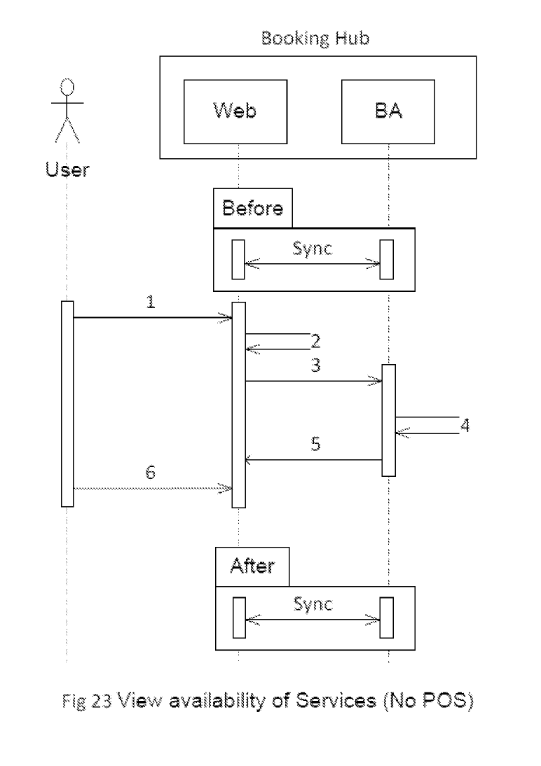

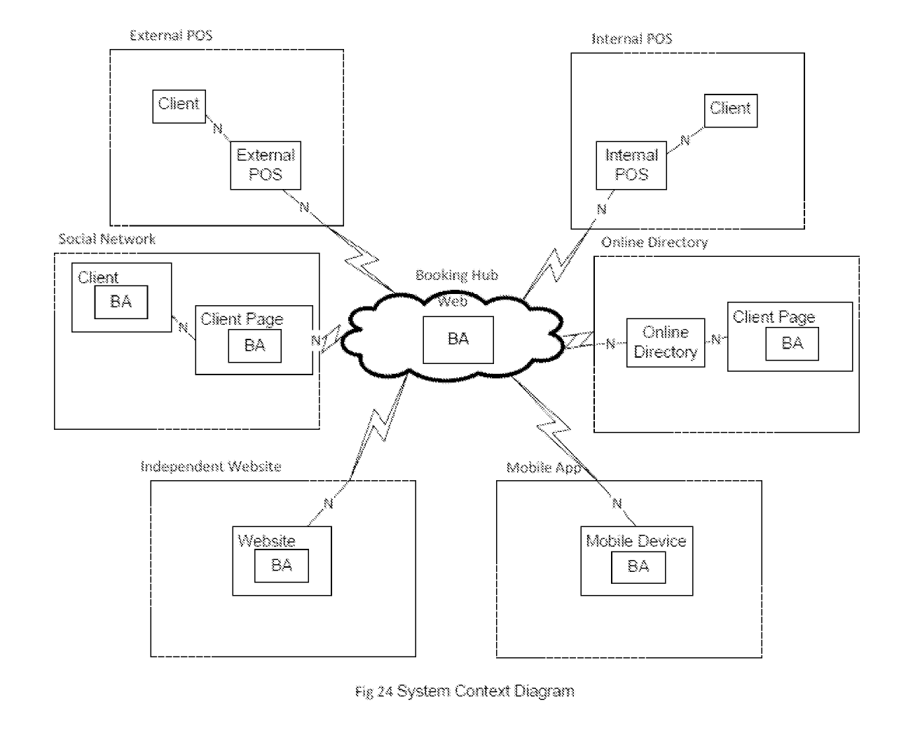

FIG. 21 is a system context diagram. In this illustration, one or more users/clients can access the booking hub via one or more EPOSs that sync with the booking hub. One or more users/clients can access the booking hub via the IPOS that syncs with the booking hub. A social network website can be comprised of one or more clients, each being provided a App that either directly or through a fan page syncs with the booking hub. An online directory is comprised of one or more client/business pages that are presented with a App by one or more directories that sync with the booking hub. A private website is comprised of one or more business websites that are presented with a App that syncs with the booking hub. The booking hub syncs with the EPOS, IPOS, Social Networks, Online Directories, Private Websites and Mobile Apps. The booking hub consists of a system website and server and booking manager, which provides synchronization among all Apps simultaneously.

The booking hub may also update the user account, assign booking to the user account, and assign reward points to the user account. Points are accumulated by users and may be later redeemed for services for free or offered at a discount in exchange for the redemption of points.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for electronic reservations, booking, and payments comprising:
providing a computer system;
providing software for instructing a computer system to execute a process;
executing the series of commands provided by the software on the computer system, the process comprising the steps of:
sending and receiving information to and from a user by a POS system;
checking availability of an event and confirm availability to a user by access to a booking hub by an EPOS;
said booking hub consists of a system website and server and booking manager, receiving the availability inquiry by the App;
receiving the availability inquiry by the App;
providing confirmation and reservation actions by the App;
updating and tracking availability by allocating and blocking openings for the business by the App;
providing both user and business account information and tracking by a user management module;
making a reservation; and
updating and crediting appropriately both the user and business accounts when a reservation is made.

2. The method of claim 1, further comprising the steps of:
providing a booking hub consisting of a system website and server and booking manager;
sending and receiving information to and from a user via a booking manager;
checking availability of an event and confirm availability to a user by access to a booking manager;
receiving, by the booking manager, the availability inquiry and provides confirmation and reservation actions;
updating and tracking availability by allocating and blocking openings for the business and communicates with the EPOS;
providing both user and business account information and tracking by the user management module updating both the user and business accounts are updated and credited appropriately when a reservation is made in the system;
providing the booking manager the availability from the EPOS and the website does not need to confirm availability, via the booking manager, with the EPOS.
making booking available to the booking manager always or it can be called upon as necessary by the booking manager to provide or confirm availability by the EPOS.
updating the user account, assign booking to the user account, and assign reward points to the user account by the booking hub;
accumulating points by users that are later redeemed for services for free or offered at a discount in exchange for the redemption of points.

3. The method of claim 1, further comprising the steps of:
booking via App on a social network website;
sending and receiving information via the App on the social network website to and from a user;
checking availability of an event and confirming availability to a user by access to a booking hub;
receiving, by the booking manager, the availability inquiry and provides confirmation and reservation actions;
updating and tracking availability by allocating and blocking openings for the business and communicates with the EPOS;
providing, by the user management module, both user and business account information and tracking;
updating and crediting both the user and business accounts appropriately when a reservation is made;
updating, via the booking hub, the user account, assigning booking to the user account, and assigning reward points to the user account;
accumulating points by users and may be later redeemed for services for free or offered at a discount in exchange for the redemption of points.

4. The method of claim 1, further comprising the steps of:
booking via mobile App;
sending and receiving, via the mobile App, information to and from a user;
checking availability of an event and confirming availability to a user by access to a booking hub;
receiving, by the booking manager, the availability inquiry and provides confirmation and reservation actions as well as updating and tracking availability by allocating and blocking openings for the business and communicates with the EPOS;
providing, by the user management module, both user and business account information and tracking;
updating and crediting appropriately both the user and business accounts when a reservation is made;
updating, by the booking hub, the user account, assigning booking to the user account, and assigning reward points to the user account;
accumulating points by users and may be later redeemed for services for free or offered at a discount in exchange for the redemption of points.

5. The method of claim 1, further comprising the steps of:
sending and receiving information, by the App on a third party website to and from a user;
checking availability of an event and confirming availability to a user by access to a booking hub;
receiving, by the booking manager, the availability inquiry and providing confirmation and reservation actions as well as updating and tracking availability by allocating and blocking openings for the business and communicates with the EPOS;
providing both user and business account information and tracking by the user management module;
updating and crediting appropriately the user and business accounts when a reservation is made;
providing a website with EPOS that is any third party website or the website owned and/or operated by a specific business that incorporates the App into their own website rather than that operated or owned by a third party;
updating the user account, assigning booking to the user account, and assigning reward points to the user account by the booking hub may also;
accumulating points by users later redeemed for services for free or offered at a discount in exchange for the redemption of points.

6. The method of claim 1, further comprising the steps of:
booking via a App on a directory website with EPOS in a directory website;
sending and receiving, by the App, information to and from a user and can check availability of an event and confirm availability to a user by access to a booking hub;
receiving, by the booking manager, the availability inquiry and provides confirmation and reservation actions;
updating and tracking availability by allocating and blocking openings for the business and communicates with the EPOS;
providing both user and business account information and tracking by the user management module;
updating and crediting appropriately both the user and business accounts when a reservation is made;
updating the user account, assigning booking to the user account, and assigning reward points to the user account by the booking hub may also;
accumulating points by users later redeemed for services for free or offered at a discount in exchange for the redemption of points.

7. The method of claim 1, further comprising the steps of:
booking via an internal POS system (IPOS);
sending and receiving information by the IPOS to and from a user;
checking availability of an event and confirming availability to a user by accessing to a booking hub;
receiving, by the booking manager, the availability inquiry and providing confirmation and reservation actions as well as updating and tracking availability by allocating and blocking openings for the business and communicates with the booking hub;
providing, by the user management module, both user and business account information and tracking;
updating and crediting appropriately both the user and business accounts when a reservation is made;
accumulating points by users later redeemed for services for free or offered at a discount in exchange for the redemption of points.

8. The method of claim 1, further comprising the steps of:
booking via an IPOS with both EPOS and IPOS;
sending and receiving information by the IPOS to and from a user;
checking availability of an event and confirm availability to a user by access to a booking hub;
receiving by the booking hub the availability inquiry and provides confirmation and reservation actions as well as updating and tracking availability by allocating and blocking openings for the business and communicates with the EPOS;
providing both user and business account information and tracking by the user management module;
updating and crediting appropriately both the user and business accounts when a reservation is made;
updating by the booking hub the user account, assigning booking to the user account, and assigning reward points to the user account;
accumulating points by users later redeemed for services for free or offered at a discount in exchange for the redemption of points.

9. The method of claim 1, further comprising the steps of:
booking via EPOS with both EPOS and IPOS;
sending and receiving information by the EPOS to and from a user;
checking availability of an event and confirm availability to a user by accessing to a booking hub;
receiving by the booking manager the availability inquiry and providing confirmation and reservation actions as well as updating and tracking availability by allocating and blocking openings for the business and communicates with the IPOS;
providing by the user management module both user and business account information and tracking. When a reservation is made in the system, both the user and business accounts are updated and credited appropriately;
updating and crediting appropriately both the user and business accounts when a reservation is made;
updating by the booking hub the user account, assigning booking to the user account, and assigning reward points to the user account;
accumulating points by users later redeemed for services for free or offered at a discount in exchange for the redemption of points.

10. The method of claim 1, further comprising the steps of:
booking via a App on website with both EPOS and IPOS;
sending and receiving information by the App to and from a user;
checking availability of an event and confirm availability to a user by access to a booking hub;
receiving, by the booking manager, the availability inquiry and provides confirmation and reservation actions as well as updating and tracking availability by allocating and blocking openings for the business and communicates with the EPOS and IPOS;
providing by the user management module, both user and business account information and tracking;
updating and crediting appropriately both the user and business accounts when a reservation is made;
updating by the booking hub the user account, assigning booking to the user account, and assigning reward points to the user account;
accumulating points by users later redeemed for services for free or offered at a discount in exchange for the redemption of points.

11. The method of claim 1, further comprising the steps of:
booking via a mobile App;
sending and receiving information by the mobile App to and from a user;
checking availability of an event and confirm availability to a user by access to a booking hub;
receiving, by the booking manager, the availability inquiry and provides confirmation and reservation actions as well as updating and tracking availability by allocating and blocking openings for the business and communicates with the EPOS and IPOS;
providing, by the user management module, both user and business account information and tracking;
updating and crediting appropriately both the user and business accounts when a reservation is made;
updating by the booking hub the user account, assigning booking to the user account, and assigning reward points to the user account;
accumulating points by users later redeemed for services for free or offered at a discount in exchange for the redemption of points.

12. The method of claim 1, further comprising the steps of:
booking via a App on social network website with both EPOS and IPOS systems;
sending and receiving by the App on the social network website information to and from a user;
checking availability of an event and confirm availability to a user by access to a booking hub;
receiving, by the booking manager, the availability inquiry and provides confirmation and reservation actions as well as updating and tracking availability by allocating and blocking openings for the business and communicates with the EPOS and IPOS;
providing, by the user management module, both user and business account information and tracking;
updating and crediting appropriately both the user and business accounts when a reservation is made;
updating by the booking hub the user account, assigning booking to the user account, and assigning reward points to the user account;
accumulating points by users later redeemed for services for free or offered at a discount in exchange for the redemption of points.

13. The method of claim 1, further comprising the steps of:
booking via a App on the website with both EPOS and IPOS;
sending and receiving by the App information to and from a user;
checking availability of an event and confirming availability to a user by access to a booking hub;
receiving, by the booking manager, the availability inquiry and provides confirmation and reservation actions as well as updating and tracking availability by allocating and blocking openings for the business and communicates with the EPOS and IPOS;
providing, by the user management module, both user and business account information and tracking;
updating and crediting appropriately both the user and business accounts when a reservation is made;
updating by the booking hub the user account, assigning booking to the user account, and assigning reward points to the user account;
accumulating points by users later redeemed for services for free or offered at a discount in exchange for the redemption of points.

14. The method of claim 1, further comprising the steps of:
booking via a App on a directory website with both EPOS and IPOS;
sending and receiving by the App information to and from a user;
checking availability of an event and confirm availability to a user by access to a booking hub;
receiving, by the booking manager, the availability inquiry and provides confirmation and reservation actions as well as updating and tracking availability by allocating and blocking openings for the business and communicates with the EPOS and IPOS;
providing, by the user management module, both user and business account information and tracking;
updating and crediting appropriately both the user and business accounts when a reservation is made;
updating by the booking hub the user account, assigning booking to the user account, and assigning reward points to the user account;
accumulating points by users later redeemed for services for free or offered at a discount in exchange for the redemption of points.

15. The method of claim 1, further comprising the steps of:
directly accessing by the user to the booking hub by the system website and server;
sending and receiving information by the system website to and from a user via the booking hub;
checking availability of an event and confirm availability to a user by access the booking manager in the booking hub;
receiving, by the booking manager, the availability inquiry and providing confirmation and reservation actions as well as updating and tracking availability by allocating and blocking openings for the business from the booking manager and communicates booking information to booking managers located on social websites and/or mobile applications;
providing, by the user management module, both user and business account information and tracking;
updating and crediting appropriately both the user and business accounts when a reservation is made;
updating by the booking hub the user account, assigning booking to the user account, and assigning reward points to the user account;
accumulating points by users later redeemed for services for free or offered at a discount in exchange for the redemption of points.

16. The method of claim 1, further comprising the steps of:
viewing availability with EPOS;
accessing the booking hub to view the availability of services;
validating, and checking by the booking hub, with the EPOS;
returning the EPOS results as a display to the system website for the user to view;
updating by the booking hub the user account, assigning booking to the user account, and assigning reward points to the user account;
accumulating points by users later redeemed for services for free or offered at a discount in exchange for the redemption of points.

17. The method of claim 1, further comprising the steps of:
viewing availability with IPOS;
accessing the booking hub to view the availability of services;
validating and checking by the booking hub with the EPOS;
returning the EPOS results as a display to the system website for the user to view;
updating by the booking hub the user account, assigning booking to the user account, and assigning reward points to the user account;
accumulating points by users later redeemed for services for free or offered at a discount in exchange for the redemption of points.

18. The method of claim 1, further comprising the steps of:
viewing availability with both EPOS and IPOS;
accessing the booking hub to view the availability of services;
validating and checking by the booking hub with the EPOS and IPOS;
returning the EPOS and IPOS results as a display to the system website for the user to view;
updating by the booking hub the user account, assigning booking to the user account, and assigning reward points to the user account;
accumulating points by users later redeemed for services for free or offered at a discount in exchange for the redemption of points.

19. The method of claim 1, further comprising the steps of:
accessing the booking hub to view the availability of services;
validating and checking by the booking hub availability via the booking manager;
returning the results as a display to the system website for the user to view;
updating by the booking hub the user account, assigning booking to the user account, and assigning reward points to the user account;
accumulating points by users later redeemed for services for free or offered at a discount in exchange for the redemption of points.

20. The method of claim 1, further comprising the steps of:
accessing the booking hub by one or more users/clients via one or more EPOSs that sync with the booking hub;
accessing the booking hub by one or more users/clients via the IPOS that syncs with the booking hub;
providing a social network website comprised of one or more clients, each being provided a App that either directly or through a fan page syncs with the booking hub;
providing an online directory comprised of one or more client/business pages that are presented with a App by one or more directories that sync with the booking hub;
providing a private website comprised of one or more business websites that are presented with a App that syncs with the booking hub;
syncing the booking hub with the EPOS, IPOS, Social Networks, Online Directories, Private Websites and Mobile Apps;
providing synchronization among all Apps simultaneously by the booking hub;
updating by the booking hub the user account, assigning booking to the user account, and assigning reward points to the user account;
accumulating points by users later redeemed for services for free or offered at a discount in exchange for the redemption of points.
